(19) United States
(12) Patent Application Publication
(10) Pub. No.: US 2004/0213575 A1
(43) Pub. Date: Oct. 28, 2004

(54) Optical add drop multiplexer system

(75) Inventor: Shiaki Aono, Miyagi (JP)

Correspondence Address: McGinn & Gibb, PLLC, Suite 200, 8321 Old Courthouse Road, Vienna, VA, 22182-3817, US

(73) Assignee: NEC Miyagi, Ltd., Kurokawa-gun (JP)

(21) Appl. No.: 10/305,239

(22) Filed: Nov. 27, 2002

(30) Foreign Application Priority Data
Dec. 5, 2001 (JP) 370792/2001

(51) Int. Cl. G02B 6/28; H04J 14/02

(52) U.S. Cl. 398/83; 385/24

(57) ABSTRACT

Variations in a peak power level of add signals due to transmission trouble are to be reduced with a relatively inexpensive and simple configuration. When an input of optical signals to an optical amplifier unit is cut off by transmission trouble, only amplified spontaneous emission light is supplied from the optical amplifier unit. An output power constant control unit amplifies this amplified spontaneous emission light to a certain level. This amplification level is substantially equal to what it would be if the input optical signals were inputted into the optical amplifier unit. This makes it possible to restrain variations in a ratio of OADM add signals to be added to OADM through signals in an OADM unit in time of transmission trouble.

### BACKGROUND OF THE INVENTION

1. Field of the Invention

The present invention relates to an optical add drop multiplexer system, and more particularly to an optical add drop multiplexer system for use in optical wavelength multiplex transmission.

2. Description of the Related Art

An optical add drop multiplexer (OADM) system is a system that adds a light of a specific wavelength to lights of a prescribed plurality of wavelengths or drops a light of a specific wavelength from lights of a prescribed plurality of wavelengths.

In an OADM system according to the prior art, if some trouble occurs on a transmission path on an input side, a peak power of signals added by the OADM system (hereinafter referred to as add signals) will vary significantly. Thus, transmission trouble on the input side would invite errors in the transmission of add signals. To address this problem, there has been developed a technique by which variations in OADM input power are compensated for by adding saturation light or the like.

This prior technique, however, involves its own problems: (1) a source of saturation light and other control parts are expensive; (2) as the band in which saturation light is to be added is confined to an amplifiable band of the optical amplifier, the number of optical wavelengths that can be added is limited; and (3) sophisticated control is required, because outputting saturation light on the transmission path gives rise to a nonlinear effect of light.

### SUMMARY OF THE INVENTION

An object of the present invention, therefore is to provide an OADM system which requires no addition of saturation light or the like and can reduce variations in a peak power level of add signals due to transmission trouble with a relatively inexpensive and simple configuration.

In order to solve the problem noted above, an optical add drop multiplexer system according to the present invention for use in optical wavelength multiplex transmission including an optical amplifier means which amplifies optical wavelength multiplex signals that are inputted, an optical control means which controls the level of optical wavelength multiplex signals or of amplified spontaneous emission light supplied from the optical amplifier unit to a prescribed level, and an add drop multiplexer means which adds to, or drops from, the output light from the optical control unit optical signals of a prescribed wavelength.

According to the present invention, since it uses a configuration which utilizes the characteristics of an amplified spontaneous emission light from the optical amplifier unit to control the output power of the optical amplifier unit at a constant level, there is no need to add saturation light or the like, and it becomes possible to reduce variations in the peak power level of add signals due to transmission trouble with a relatively inexpensive and simple configuration.

The present invention realizes a function to restrain variations in the ratio between OADM through signals and OADM add signals, when transmission trouble or the like has cut off optical wavelength multiplex signals to be inputted into an optical amplifier unit in an OADM system for optical wavelength multiplex transmission use, by utilizing the characteristics of an amplified spontaneous emission (ASE) output of the optical amplifier unit to control the output power of the optical amplifier unit at a constant level and thereby keeping constant the level of light inputted into an OADM unit. Furthermore, the restraint on variations in the ratio between OADM through signals and OADM add signals results in a KeepAlive function to keep the OADM add signals free from errors.

The ASE here, which means amplified spontaneous emission light arising in the optical amplifier unit, is a sort of noise. The KeepAlive function means a function to raise the ASE to a prescribed power level when optical wavelength multiplex signals which would otherwise be inputted into the optical amplifier unit are cut off by transmission trouble or the like.

Next will be briefly described the operation of the OADM system. Referring to FIG. 1, when an optical wave length multiplex signal input 7 is cut off, an output of an optical amplifier unit 2 is deprived of optical wavelength multiplex signals, leaving only the ASE. However, since an output power constant control unit 3 is provided on an output side of the optical amplifier unit 2, the ASE is controlled to the same level as what it would be if there were the optical wavelength multiplex signals. Therefore, the control is so effected as to keep an input level of an OADM unit 4 constant, so that variations in the ratio between OADM through signals 8 and OADM add signals 10 on an input side of an optical amplifier unit 5 can be restrained, and so can be variations in a peak power level of the OADM add signals 10 at an output of the optical amplifier unit 5 to a certain level (a permissible level of the quantity of variations at which the OADM add signals can be transmitted without error) or below.

### BRIEF DESCRIPTION OF THE DRAWINGS

FIG. 1 illustrates a configuration of an optical add drop multiplexer system, which is a first preferred embodiment of the present invention;

FIG. 2 is a patterned diagram illustrating an outline of an operation of an OADM unit 4 in the optical add drop multiplexer system; and

FIG. 3 illustrates a configuration of another optical add drop multiplexer system, which is a second preferred embodiment of the invention.

### DESCRIPTION OF THE PREFERRED EMBODIMENTS

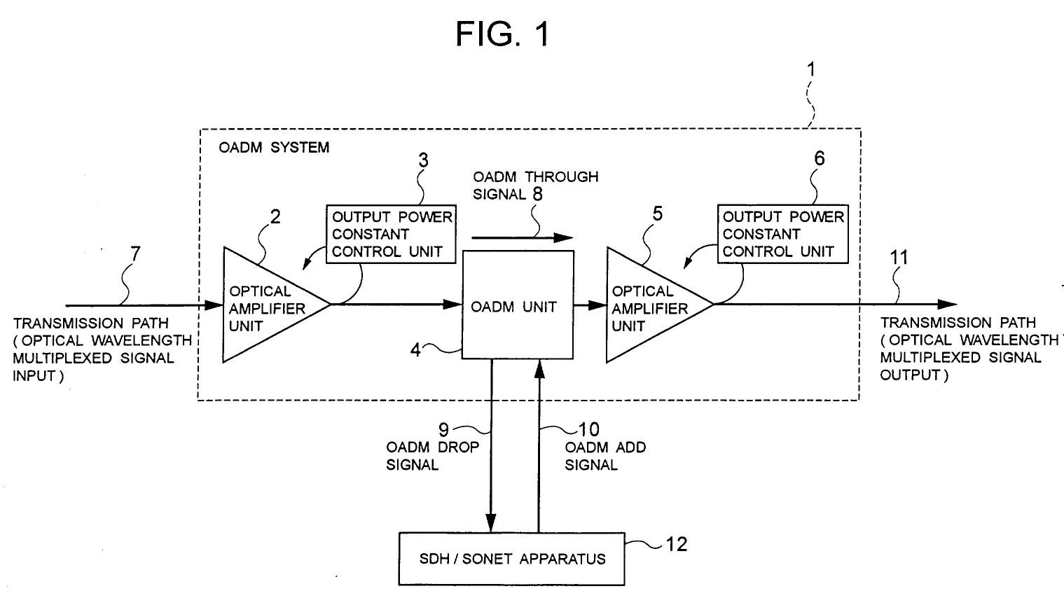

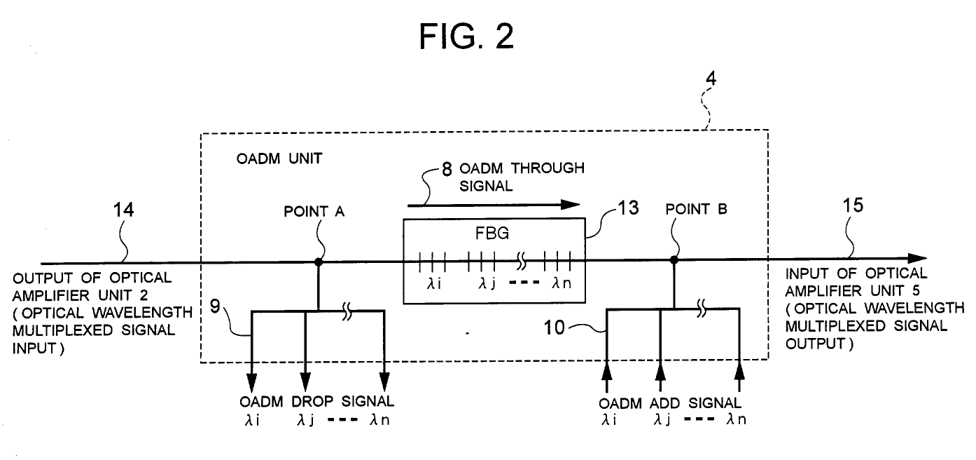

Preferred embodiments of the present invention will be described below with reference to the accompanying drawings. First will be described a first embodiment. FIG. 1 illustrates a configuration of an optical add drop multiplexer system, which is a first preferred embodiment of the present invention, and FIG. 2 is a patterned diagram illustrating an outline of an operation of an OADM unit 4 in the optical add drop multiplexer system.

Before explaining FIG. 1, it may be useful to describe the operation of the OADM unit 4 in the optical add drop multiplexer system with reference to FIG. 2. Optical wavelength multiplex signals 14 inputted from the optical amplifier unit 2 into the OADM unit 4 are demultiplexed into OADM drop signals 9 and OADM through signals 8 at a point A in a diagram. A known fiber Bragg grating (FBG) 13 inhibits signals λi, j . . . n (i, j and n are positive integers) to be dropped from passing the signal light band, and passes only the other signals than those to be dropped, namely only the OADM through signals 8. The operation described above is accomplished by an arrangement consisting of a passive optical part, and signals of the same wavelength band are inhibited, whether an optical wavelength multiplex signal input 14 consists of signal light or of ASE signals. After that, the OADM through signals 8 and the OADM add signals 10 are multiplexed at a point B in FIG. 2, and finally the multiplexed signals are supplied from the OADM unit 4 as an optical wavelength multiplex signal output 15. However, the wavelengths λ of the OADM drop signals 9, the pass inhibitory wave at the FBG 13 and the OADM add signals 10 are all of the same combinations as shown below:

Drop λi=FBG λi=Add λi

Drop λj=FBG λj=Add λj

Drop λn=FBG λn=Add λn

Next will be described a configuration of the optical add drop multiplexer (OADM) system with reference to FIG. 1. An OADM system 1 comprises the optical amplifier unit (Amp unit) 2 for amplifying optical wavelength multiplex signals 7 inputted from the transmission path, an output power constant control unit 3 for controlling the output power of the optical amplifier unit 2, the OADM unit 4 for realizing the OADM function, an optical amplifier unit (Amp unit) 5 for amplifying the output of the OADM unit 4 to the optimal level for supplying to the transmission path, and an output power constant control unit 6 for controlling the output power of the optical amplifier unit 5.

Further, the ODAM add signals 10 are supplied from an external synchronous digital hierarchy/synchronous optical network (SDH/SONET) apparatus 12 to the OADM unit 4, and the OADM drop signals 9 are supplied from the OADM unit 4 to the SDH/SONET apparatus 12.

If the input of the optical wavelength multiplex signals 7 here is cut off when the transmission path is in trouble, the output of the optical amplifier unit 2 will be deprived of optical wavelength multiplex signals, leaving only ASE. However, since the output power constant control unit 3 is provided on an output side of the optical amplifier unit 2, the control is so effect that the ASE output remains at the same level as what it would be if there were the optical wavelength multiplex signals. Therefore, the input level at the OADM unit 4 is kept constant by the ASE input, and the ASE becomes the OADM through signals 8 as stated above and is added to the OADM add signals 10 (at a constant level) at substantially the same rate before the input of the optical wavelength multiplex signals 7 is cut off. Thus, since variations in the ratio between the OADM through signals 8 and the OADM add signals 10 and those between the ASE and the ODAM add signals 10 are restrained, variations in the peak power level of the OADM add signals 10 at the output of the optical amplifier unit 5 are kept below a certain level, with the result that there is realized the KeepAlive function to transmit the OADM add signals 10 without error even when the transmission path is in trouble.

Next will be described the operation of the optical add drop multiplexer system. If any trouble arises on the transmission path on the input side of the OADM system 1, the input level of the optical wavelength multiplex signals 7 will drop. However, as the output power constant control unit 3 is provided on the output side of the optical amplifier unit 2, when the speed is higher than the decreasing slope of the optical wavelength multiplex signals 7 where the time constant of control is inputted, the output of the optical amplifier unit 2 is kept constant all the time by the output of the ASE irrespective of the drop of the optical wavelength multiplex signals 7.

On the other hand, in the OADM unit 4 the wavelength band of the OADM drop signals 9 of the ASE is inhibited by a passive optical part irrespective of the decreasing slope of the optical wavelength multiplex signal input 7, and the ASE of which the wavelength band of the OADM drop signals 9 is inhibited (corresponding to the OADM through signals 8 in this case) is multiplexed with the OADM add signals 10, which are then supplied.

Therefore, the restraint on the output level variations of the optical amplifier unit 2 serves to restrain variations in the ratio of the ODAM add signals 10 to the OADM through signals 8. Finally on the output side of the optical amplifier unit 5, the output power constant control unit 6 is provided similarly to the optical amplifier unit 2 and this output power constant control unit 6 restrains variations in the ratio of the OADM add signals 10, so that the peak power variations of the OADM add signals 10 on the output side of the optical amplifier unit 5 are also restrained below a certain level.

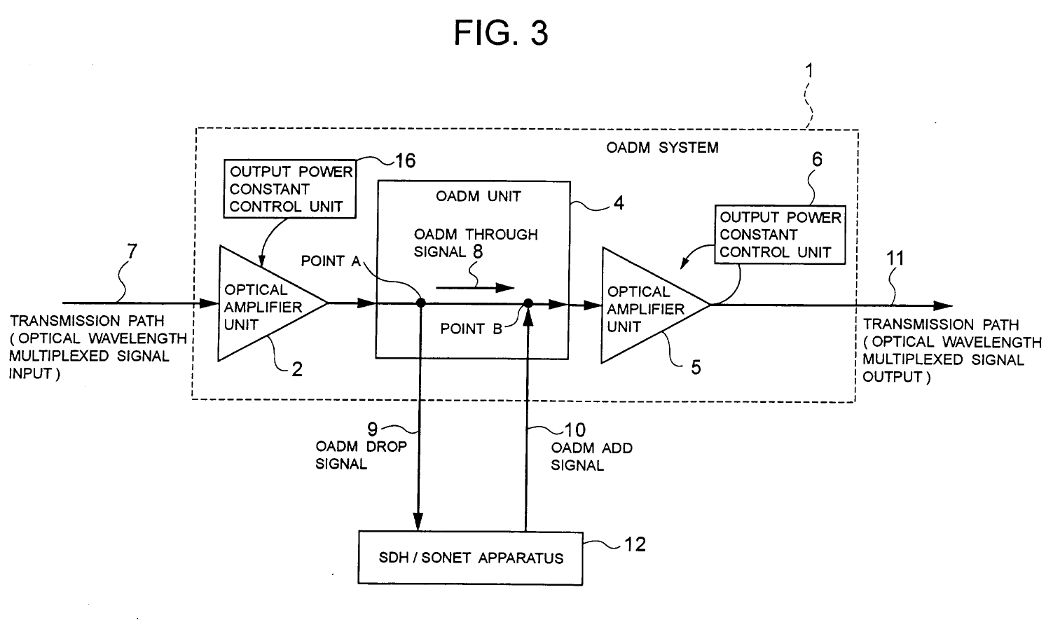

Next will be described a second preferred embodiment of the present invention. FIG. 3 illustrates a configuration of another OADM system, which is the second preferred embodiment. In FIG. 3, the same constituents as in FIG. 1 will be denoted by respectively the same reference numbers, and their description will be omitted. Referring to FIG. 3, the second embodiment differs from the first embodiment only in that the output power constant control unit 3 in the first embodiment (see FIG. 1) is replaced by an output power constant control unit 16 (see FIG. 3). With this output power constant control unit 16, the second embodiment can restrain variations in the ratio between the OADM through signals 8 and the OADM add signals 10 even more precisely than the first embodiment.

While the output power constant control unit 3 in the first embodiment controls the output level of the optical amplifier unit 2, the output power constant control unit 16 in the second embodiment controls the level of the OADM through signals 8 at a point B in the OADM unit 4, namely the point where the OADM through signals 8 and the OADM add signals 10 are multiplexed.

When the wavelength band of the OADM drop signals 9 in the optical wavelength multiplex signals 7 is inhibited at a point A, the level of the OADM through signals 8 at the point B is reduced correspondingly. Therefore, the output power constant control unit 16 effects such control as keeps that reduced level of the OADM through signals 8 at a prescribed level.

On the other hand, when the input 7 is cut off, the ASE alone remains as the output of the optical amplifier unit 2. However, even though the wavelength band of the OADM drop signals 9 of the ASE is inhibited at the point A, the level of the OADM through signals 8 at the point B does not drop correspondingly and maintains substantially its original level, because the ASE is noise (because it contains consecutive frequency components). Therefore, the output power constant control unit 16 effects such control as keeps this level at the aforementioned prescribed level.

That is, in this case, as the ratio of the ODAM add signals 10 to the OADM through signals 8 lowers, the peak power of the ODAM add signals 10 supplied from the OADM system 1 drops. This occurs because the level difference between where the OADM through signals 8 are optical wavelength multiplex signals and where they are ASE can be reduced by the output power constant control unit 16 of the optical amplifier unit 2.

According to the present invention, as the optical add drop multiplexer system for use in optical wavelength multiplex transmission comprises an optical amplifier unit which amplifies optical wavelength multiplex signals that are inputted, an optical control unit which controls the level of optical wavelength multiplex signals or of amplified spontaneous emission light supplied from the optical amplifier unit to a prescribed level, and an add drop multiplexer unit which adds to, or drops from, the output light from the optical control unit optical signals of a prescribed wavelength, there is no need to add saturation light or the like and it is possible to reduce variations in the peak power level of add signals due to transmission trouble with a relatively inexpensive and simple configuration.

More specifically, according to the present invention, even if trouble occurs on the transmission path on the input side of the OADM system 1 shown in FIG. 1, as variations in the peak power level of OADM add signals 10 supplied from the OADM system 1 are restrained below a certain level, the transmission of OADM add signals 10 over the transmission path not in trouble can be kept free from errors.

Furthermore, after the transmission path is restored from trouble, since only the output of the optical amplifier unit 2 changes from ASE to optical wavelength multiplex signals and variations in the output level can be restrained, variations in the peak power level of OADM add signals 10 supplied from the OADM system 1 are restrained below a certain level as at the time of trouble occurrence, the transmission of OADM add signals 10 over the transmission path not in trouble can be kept free from errors.

In addition, because the present invention makes use of the ASE characteristics of the optical amplifier, the following advantages are provided: (1) there is no difference in cost from the prior art, (2) the whole amplifier band can be used and the number of multiplexed optical wavelengths is unaffected, as ASE is inhibited by the FBG within the OADM, and (3) even if ASE is supplied onto the transmission path, there is little likelihood for a nonlinear effect to occur because the peak power of each wavelength is low (the power density is low).

What is claimed is:

1. An optical add drop multiplexer system for use in optical wavelength multiplex transmission, comprising:
an optical amplifier means which amplifies optical wavelength multiplex signals that are inputted, an optical control means which controls the level of optical wavelength multiplex signals or of amplified spontaneous emission light supplied from the optical amplifier unit to a prescribed level, and an add drop multiplexer means which adds to, or drops from, the output light from the optical control means optical signals of a prescribed wavelength.

2. The optical add drop multiplexer system according to claim 1, wherein said optical control means controls the level of through signals at the adding point of said through signals and prescribed wavelength signals within said add drop multiplexer means.

3. The optical add drop multiplexer system according to claim 1, wherein said optical control means controls, when the input of optical wavelength multiplex signals to said optical amplifier means is cut off, the level of said amplified spontaneous emission light supplied from said optical amplifier means.

4. The optical add drop multiplexer system according to claim 1, further comprising a second optical amplifier means which amplifies signals supplied from said add drop multiplexer means.

5. The optical add drop multiplexer system according to claim 2, wherein said through signals include other signals than the signals to be dropped.

6. The optical add drop multiplexer system according to claim 1, wherein said add drop multiplexer means adds signals after signals are dropped.

7. The optical add drop multiplexer system according to claim 1, wherein said optical control means controls, when optical wavelength multiplex signals are inputted into said optical amplifier means, the level of said optical wavelength multiplex signals supplied from said optical amplifier means.

8. The optical add drop multiplexer system according to claim 3, wherein said optical control means effects control, when the input of optical wavelength multiplex signals to said optical amplifier means is cut off, so as to keep the level of said amplified spontaneous emission light supplied from said optical amplifier means at the same level as what it would be if there were said optical wavelength multiplex signals.

9. The optical add drop multiplexer system according to claim 1, wherein said add drop multiplexer means includes a passive optical part which inhibits a certain signal light band from passing.

10. The optical wave add drop multiplexer system according to claim 9, wherein said passive optical part is configured of a fiber Bragg grating (FBG).
